(19) United States
(12) Patent Application Publication
(10) Pub. No.: US 2010/0103134 A1
(43) Pub. Date: Apr. 29, 2010

(54) METHOD AND APPARATUS FOR PROCESSING MULTI-TOUCH INPUT OF TOUCH-SCREEN

(75) Inventor: Hyung Chul JUNG, Gyeonggi-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/605,740

(22) Filed: Oct. 26, 2009

(30) Foreign Application Priority Data
Oct. 28, 2008 (KR) 10-2008-0106029

(51) Int. Cl. G06F 3/041

(52) U.S. Cl. 345/173

(57) ABSTRACT

The present invention relates to a multi-touch input processing method and apparatus of a touch screen. The present invention preferably provides a method including: storing a first coordinate inputted by a multi-touch which becomes a second touch input in a state where a first touch input is maintained; cancelling the first touch input in a state where the second touch input is maintained; storing a second coordinate set by the cancel of the first touch input; storing a third coordinate set by a third touch input in a state where the second touch input is maintained; and checking a sameness of a first vector from the first coordinate to the second coordinate and a second vector from the second coordinate to the third coordinate, and determining a touch of the second coordinate as being effective in case the first vector and the second vector are not identical.

### CLAIM OF PRIORITY

This application claims the benefit under 35 U.S.C. §119(a) of a Korean patent application filed in the Korean Intellectual Property Office on Oct. 28, 2008 and assigned Serial No. 2008-0106029, and the entire disclosure of which is hereby incorporated by reference in its entirety.

### BACKGROUND OF THE INVENTION

1. Field of the Invention

The present invention relates to a method and apparatus for processing a touch input. More particularly, the present invention relates to a multi-touch input processing method and apparatus of touch screen capable of processing an error occurrence caused by the generation of a multi-touch in a touch screen of piezoelectric type which is not able to sense the multi-touch.

2. Description of the Related Art

Recently manufactured portable terminals are slimmer in size than their predecessors, and continued miniaturization of portable terminals is be researched to satisfy user demands for the most compact portable terminal available that also provides a plurality of functions and is reliable. In conjunction with such trends, there has been some increased focus on the development of a new input unit that resolves the problems associated with conventional button type input units. As the size of portable terminals continue to decrease, the area occupied by the conventional buttons essentially increases because they have not been significantly reduced in size. Particularly, attention has shifted to an input mode utilizing a touch screen, which completely breaks from the conventional input mode of conventional key buttons.

Generally, the touch screen is one of a number of input devices configuring an interface between an IT apparatus using various displays and a user, enabling an interface between the IT apparatus and the user when the use directly contacts a screen by an input instrument including a finger or a touch pen. Since virtually anyone, for example, people of all ages and both sexes, can easily use the touch screen by just contacting an input instrument including a finger, a touch pen or the like, the touch screen is used for various instruments such as Automated Teller Machine ATM, Personal Digital Assistant PDA, and a mobile phone, and used in various fields such as a bank, a government office, and a sightseeing and traffic guidance.

Various methods for touch screen operation currently include a piezoelectric method, a capacitive method, an ultrasonic wave method, an infrared method, and a surface acoustic wave method can be applied to a touch screen. Typical portable terminal use a touch screen of a piezoelectric type, which is not expensive, capable of making use of various input instruments including a finger, a pen or the like. However, the touch screen of piezoelectric type can process only one touch event at a time. In other words, the touch screen of piezoelectric type has a problem of recognizing that an intermediate point of two points which are multi-touched is touched in the generation of a multi-touch action. Particularly, when a user inputs characters in the touch screen having such a problem, if the user touches a second touch spot before taking away user's finger from a spot which is first touched by user so that the multi-touch is generated, a conventional portable terminal is unable to sense the touch event or senses that other area is touched. Accordingly, it is disadvantageous in that characters can be differently inputted from the intention of the user.

### SUMMARY OF THE INVENTION

The present invention provides a multi-touch input processing method and apparatus of touch screen for processing an error occurrence caused by the generation of a multi-touch action in a touch screen of a piezoelectric type, which is not able to sense the multi-touch action.

In accordance with an exemplary aspect of the present invention, a method of processing a touch input of a touch screen preferably includes: sensing a first touch input on the touch screen; storing a first coordinate sensed as a multi-touch input that becomes a second touch input in a state in which the first touch input on the touch screen is maintained; cancelling the first touch input in a state in which the second touch input is maintained; storing a second coordinate set in response to a cancelation of the first touch input; storing a third coordinate set by a third touch input in a state in which the second touch input on the touch screen is maintained; and checking a sameness of a first vector from the first coordinate to the second coordinate and a second vector from the second coordinate to the third coordinate, and determining a touch of the second coordinate as being effective in case the first vector and the second vector are not identical.

In accordance with another exemplary aspect of the present invention, an apparatus for processing a touch input of a touch screen preferably includes: a touch screen configured for sensing a touch input of user; a first buffer which is configured to store a first coordinate set by a second touch input in a state in which a previously sensed first touch input is maintained on touch screen, to store a second coordinate set by a cancel of the first touch input, and to store a third coordinate set by a third touch input sensed by touch screen in a state in which the second touch input is maintained; a vector calculation unit configured for calculating a first vector between the first coordinate and the second coordinate, and for calculating a second vector between the second coordinate and the third coordinate if the third coordinate is inputted to a storage unit; a second buffer configured for storing the first vector and the second vector calculated by the vector calculation unit; and a controller configured for checking a sameness of the first vector and the second vector that are stored in the second buffer, and to determine a touch of the second coordinate as being effective in case the first vector and the second vector are not identical.

### BRIEF DESCRIPTION OF THE DRAWINGS

The above and other aspects, features, and advantages of certain exemplary embodiments of the present invention will become more apparent from the following description taken in conjunction with the accompanying drawings, in which:

FIG. 1 is a block diagram illustrating a schematic configuration of a portable terminal according to an exemplary embodiment of the present invention;

FIG. 2 is an exemplary diagram illustrating a multi-touch input process of a piezoelectric type touch screen according to an exemplary embodiment of the present invention; and

FIG. 3 is a flowchart illustrating a multi-touch input process of a piezoelectric type touch screen according to an exemplary embodiment of the present invention.

### DETAILED DESCRIPTION

Exemplary embodiments of the present invention are described herein in detail with reference to the accompanying drawings. The same or similar reference numbers are used throughout the drawings to refer to the same or like parts. Detailed descriptions of well-known functions and structures incorporated herein may be omitted to avoid obscuring appreciation of the subject matter of the present invention by a person of ordinary skill in the art.

The present invention may be embodied in many different forms and should not be construed as limited to the exemplary embodiments set forth herein. Rather, these exemplary embodiments are provided so that this disclosure is thorough, and will enable the invention to those skilled in the art. For illustrative purposes, a portable terminal according to the present invention will be described as a mobile communication terminal in the below. However, it should be noted that the present invention is not limited to a mobile communication terminal. Preferably, the present invention can be applied to all types of communication and information devices, multimedia devices, and the applications thereof, including but in no way limited to a personal digital assistant (PDA), a smart phone, an international mobile telecommunication 2000 (IMT-2000) terminal, a code division multiple access (CDMA) terminal, a wideband code division multiple access (WCDMA) terminal, a global system for mobile communication (GSM) terminal, a general packet radio service (GPRS) terminal, an enhanced data GSM environment (EDGE) terminal, an universal mobile telecommunication service (UMTS) terminal, a digital broadcasting terminal, and an ATM (Automated Teller Machine).

Hereinafter, a term “touch” is used to refer a situation where a user applies pressure to a touch screen by using an input instrument including a finger, stylus or a touch pen, or the like.

Hereinafter, a term “multi-touch” is generally used to refer a situation where the “touch” is substantially simultaneously generated in at least two points of the touch screen.

Hereinafter, a term “touch cancel” is generally used to refer an operation that an input instrument is separated from the touch screen surface while the applied pressure is canceled in a situation where the input instrument including a finger, stylus and/or a touch pen or the like gives pressure to a specific spot of the touch screen to be in the “touch” state. The touch cancel can include a state where the “touch” is not sensed in any place of the touch screen.

Hereinafter, “vector” generally refers to variation between two coordinates. The vector value can have magnitude and direction.

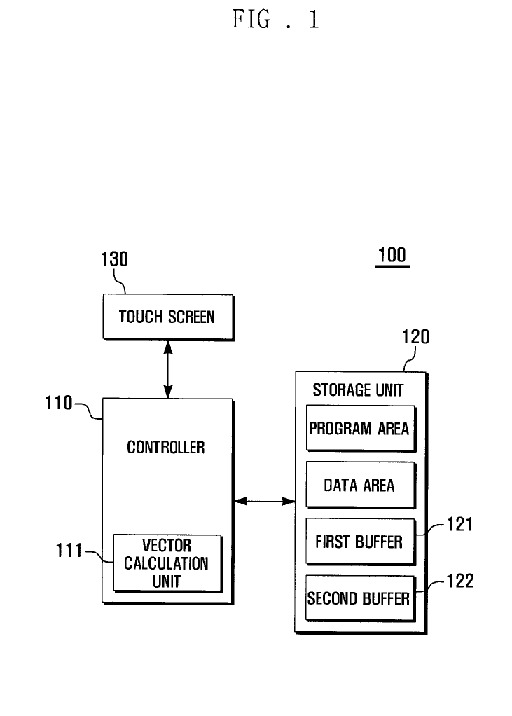

FIG. 1 is a block diagram illustrating a schematic configuration of a portable terminal 100 according to an exemplary embodiment of the present invention.

In accordance with the present invention, an apparatus processes a touch input of a touch screen and stores a coordinate caused by a second touch input as a first coordinate in a state where a first touch input is maintained, stores a second coordinate which is generated when the first touch input is cancelled in a state where the second touch input is maintained, stores a third coordinate sensed in a third touch input in a state where the second touch input is maintained, determines the sameness of a first vector between the first coordinate and the second coordinate and a second vector between the second coordinate and the third coordinate, and determines the touch of the second coordinate as being effective in case the first vector and the second vector are not identical. In the meantime, an apparatus for processing a touch input of the present invention can be set to determine the touch of the second coordinate as being effective in case an angle formed by the first vector and the second vector is a standard value (e.g. 5 degrees) or more.

Hereinafter, each configuration will be illustrated in detail.

Referring now to FIG. 1, a portable terminal 100 according to an exemplary embodiment of the present invention includes a controller 110, a touch screen 130, and a storage unit 120. The controller 110 is configured to include a vector calculation unit 111. The storage unit 120 is configured to include a first buffer 121 and a second buffer 122.

The touch screen 130 can display information inputted by user or provided to a user in addition to various menus of the portable terminal 100. Such a touch panel can be adhered to the front side of, for example, a liquid crystal display (hereinafter, LCD) so that the touch screen 130 can be formed.

The touch screen 130 can be configured, for example, with a piezoelectric type, a capacitive type, a supersonic wave reflection mode, a optical sensor and an electromagnetic induction type. Particularly, the touch screen 130 of the present invention may comprise a touch screen 130 of piezoelectric type, but is not limited to any one type. Here, according to exemplary operation of the touch screen 130 of the present invention, the upper plate of the touch screen 130 is crooked to contact with the lower plate when user applies pressure to the touch screen 130 with an input instrument including a finger or a touch pen or the like. At this time, the voltage value which flows into the upper plate and the lower plate is changed, and the coordinate of a spot which is touched can be sensed by recognizing the change of this voltage value.

The touch screen 130 can display, for example, a virtual keypad in one side when the writing for a short message, a multi message, a memo, and E-mail is requested. At this time, the touch screen 130 may display an input window for displaying characters and numbers which are inputted through the virtual keypad. If a touch input is generated in the virtual keypad, the touch screen 130 senses this, and detects the coordinate of a spot in which the touch input is generated and can transmit to the controller 110. At this time, the controller 110 can control to store the transmitted coordinate into the first buffer 121. Moreover, in case a multi-touch generation, for example, a second touch input is generated before user cancels a first touch input during the input of characters, the touch screen recognizes that a touch input is generated in the intermediate point of two points which are multi-touched due to characteristics of the touch screen of piezoelectric type.

The touch screen 130 outputs a key which is allocated to the coordinate which is determined to be effective to the input window under the control of the controller 110. The detailed description about this will be described later in the description of the controller 110.

The storage unit 120 stores user data as well as a program necessary for the operation of function of the portable terminal 100 according to an embodiment of the present invention. More particularly, the storage unit 120 includes a first buffer 121, which stores the coordinate that is transmitted from the touch screen 130, and a second buffer 122 which stores a vector value among the coordinates stored in the first buffer 121, a program area and a data area.

The program area can store a program, for example, which controls the overall operation of the portable terminal 100, an operating system (OS) which boots the portable terminal 100, an application program, for example, to provide for the playing of multimedia contents, and an application program(s) for other functional options of the portable terminal, for example, the camera function, the sound playing function, the image or moving picture playing function. Particularly, the program area can store a program for classifying the coordinate touched by an actual user among a plurality of sensed coordinates in case a touch input is not cancelled and the coordinate is continuously moved. To this end, the program area includes a program which calculates a vector value between two coordinates when the coordinate stored in the first buffer 121 is three or more and a program which determines the sameness of the vectors by comparing the vectors when the vector which is calculated and stored is two or more. The determination of the sameness of the vectors can be performed by comparing the magnitude and direction of respective vector. Alternatively, the determination of the sameness of the vectors can be performed by only comparing the direction of two vectors.

Still referring to FIG. 1, the data area is an area where data which is generated according to the use of portable terminal 100 is stored. In case the portable terminal 100 includes a camera function, it can store a photograph or a moving picture, a phone book, an audio data and information corresponding to a relevant contents, and/or user data.

The first buffer 121 receives the coordinate of a spot of the touch screen 130 where the sensing of an touch input is generated under the control of the controller 110, and the first buffer 121 can successively store the coordinate until a touch input cancel signal is inputted. Then, if the touch input cancel signal is generated, the first buffer 121 can initialize the stored coordinate. That is, if the touch input cancel signal is generated, the first buffer 121 can delete the stored coordinates.

If three or more coordinates are stored in the first buffer 121, the second buffer 122 can store a vector value between the final coordinate and the previous coordinate. That is, if a third coordinate is stored in the first buffer 121, the second buffer 122 stores the vector value which the vector calculation unit 111 calculated in a second coordinate which is previously stored and the third coordinate which is the final coordinate, as a first vector. If a fourth coordinate is inputted to the first buffer 121, the second buffer 122 stores the vector value which is calculated between the third coordinate which is the previous coordinate and the fourth coordinate which is the final coordinate, as a second vector. The first vector and the second vector can include a magnitude and direction value. Alternatively, the first vector and the second vector can include only a direction value. The second buffer 122 can initialize the stored vectors, that is, can delete in case of the touch input cancel signal. A person of ordinary skill in the art should understand and appreciate that the number of physical buffers in the invention could be 1, and the ordinal number can be referring to randomly assigned storage address in a single buffer or storage unit.

Moreover, in the above discussion, although FIG. 1 illustrated only the first buffer 121 and the second buffer 122 in the storage unit 120, an artisan should understand and appreciate that the presently claimed invention is not limited to two buffers in the storage unit. That is, the first buffer 121 and the second buffer 122 can be included in the touch screen 130 or the controller 110, or can be separately configured.

The controller 110 controls the overall operation of the portable terminal 100 and a signal flow between internal blocks of the portable terminal 100, and can perform the data processing function. Particularly, the controller 110 of the present invention can control to display the virtual keypad and the input window in one side for a short message, a long message, and a memo. At this time, if the coordinate is moved, the controller 110 can control to successively store the moved coordinates into the first buffer 121. The controller 110 can store the moved coordinate together with a key which is allocated to an area where the coordinate is included.

If a coordinate sensed by a first touch input which is generated in a state where the touch input is not generated is moved by a second touch input which is generated in a state in which the first touch input is maintained, the controller 110 determines that the touch of the coordinate is effective, so that the controller 110 controls the display to the touch screen 130 to show a number or a character corresponding to the key allocated to the sensed coordinate. Then, the controller 110 successively stores a coordinates which moves without a touch cancel into the first buffer 121. If three or more coordinates are stored in the first buffer 121, the controller 110 calculates a vector value among respective coordinates and stores into the second buffer 122 and can compare respective vector value when the calculated vector value is 2 or more. To this end, the controller 110 can include the vector calculation unit 111.

The vector calculation unit 111 may calculate the vector value among respective coordinates and successively stores the vector value into the second buffer 122 if the stored coordinate is three or more. For example, if the third coordinate is inputted to the first buffer 121, the vector calculation unit 111 can calculate a vector value between the first coordinate and the second coordinate and a vector value between the second coordinate and the third coordinate. The vector value between the first coordinate and the second coordinate can then be stored in the second buffer 122 as a first vector under the control of the controller 110. The vector value between the second coordinate and the third coordinate can be stored in the second buffer 122 as a second vector under the control of the controller 110. Such vector calculation process can be repeated until a touch input cancel signal is generated.

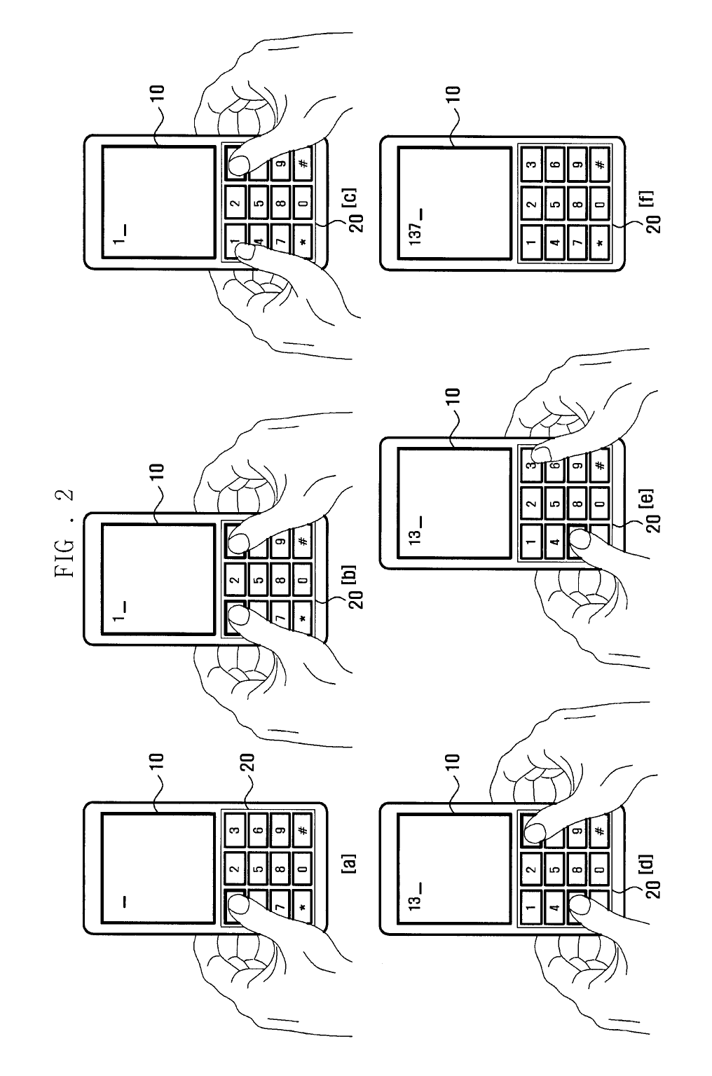

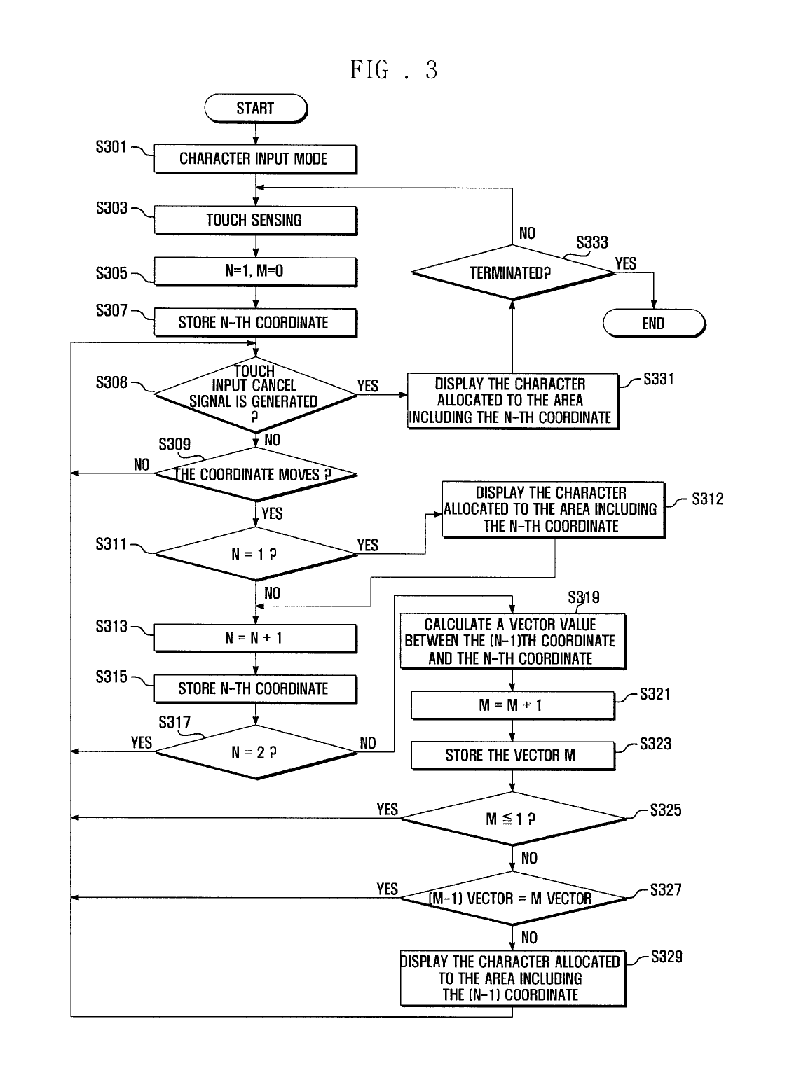

If the number of vectors stored in the second buffer 122 comprises two or more, the controller 110 can check the sameness of the stored vectors. The sameness of the vectors can be determined by comparing the magnitude and direction of the vector value or can be determined by only comparing the direction. At this time, as a result of the comparison of the vector value, if it is determined to be a different vector, the controller 110 can determine that the touch of the previous coordinate of the final coordinate is effective. On the other hand, if it is determined to be the same vector, the controller 110 can determine that the touch of the final coordinate is ineffective and can check whether the coordinate is moved. The detailed description about coordinate being moved will be described later with reference to FIGS. 2 to 3.

In the meantime, if an angle formed by the first vector and the second vector comprises a standard value (e.g., 5 degrees) or more according to the intention of designer, the controller 110 can determine that the touch of the previous coordinate of the final coordinate is effective.

In case the touch input is canceled, the controller 110 determines whether the coordinate which is finally stored in the first buffer 121 is effective, and can control the display to show the allocated key to the touch screen. Then, the controller 110 can initialize the first buffer 121 and the second buffer 122, that is, can delete the stored data.

Moreover, although not shown, the portable terminal 100 according to the present invention may selectively further include elements having a supplementary feature, such as a wireless communications unit providing a voice communications, a camera module providing an image or a moving-picture photographing function, a broadcasting reception module for the reception of digital broadcast, an audio signal output unit like a speaker, a voice signal input unit like a microphone, a connection terminal for data exchange with an external digital device, a charging terminal, and a digital sound playing module like a MP3 module, just to name a few of the possibilities. The structure of these elements is varied due to the convergence of functions in the digital device, and thus, these elements cannot be enumerated. However, there are many elements in addition to above mentioned elements that can be included in a portable terminal of the present invention.

FIG. 2 is an exemplary diagram illustrating a multi-touch input process of a piezoelectric type touch screen according to an exemplary embodiment of the present invention.

Referring now to FIG. 2, if a text input mode, for example, when the functions of short message, multi-message, memo, and e-mail writing can be activated, the portable terminal 100 preferably displays a virtual keypad 20 in one side of the touch screen 130, for example, in the bottom like a first exemplary diagram 2(a), that also shows an input window 10 in the upper end. Hereinafter, it is exemplified that a number is preferably input by using the virtual keypad 20.

If user touches a number 1 area of the virtual keypad 20 by using a left hand so as to input a number 1 like a first exemplary diagram (a) of FIG. 2 (hereinafter, a first touch input), the controller can receive the coordinate of the touched spot from a touch screen and store into the first buffer. At this time, if user cancels a touch input by taking away a finger, the controller can control the display to show the number 1 from the input window 10. On the other hand, if user touches a number 3 area of the virtual keypad 20 so as to input a number 3 before the cancel of the first touch input like a second exemplary diagram (b) of FIG. 2 (hereinafter, a second touch input), the controller can receive the coordinate (hereinafter, a first coordinate) of an intermediate point of the number 1 and the number 3 from the touch screen and can store it into the first buffer. At this time, the controller can determine the coordinate which is stored in the input of the first touch like the second exemplary diagram (b) as being effective so that it can display the allocated number to the input window 10.

If user takes away a left hand that touched the number 1 area like a third exemplary diagram (c), the controller can store the coordinate (hereinafter, a second coordinate) of a point touched by a right hand of user into the first buffer. Here, as described above, the controller can determine the coordinate set by the first touch input as being effective in the input of the second touch, or can determine the touch of the coordinate stored in the input of the first touch as being effective in the cancel of the first touch input. Moreover, the vector calculation unit can calculate a vector value between the first coordinate and the second coordinate. The vector value between the first coordinate and the second coordinate can be stored, for example, in the second buffer as the first vector under the control of the controller. At this time, the controller can check whether a touch input is cancelled, the controller controls the display to show the number 3 if the touch input is cancelled. On the other hand, if user touches a number 7 area by a left hand so as to input a number 7 before the touch input of the number 3 area is cancelled like a fourth exemplary diagram (d), the controller can store the coordinate (hereinafter, a third coordinate) of an intermediate point of the touched number 3 and the number 7 into the first buffer. At this time, the vector calculation unit can calculate a vector value between the second coordinate and the third coordinate. The vector value between the second coordinate and the third coordinate can be stored in the second buffer as the second vector under the control of the controller. At this time, the controller can check the sameness of the first vector and the second vector. As a result of the check, if two vector values are not identical, the controller preferably determines in this example that the touch of the second coordinate was effective. That is, the number 3 allocated to the second coordinate can be displayed to the input window 10 like the fourth exemplary diagram (d). Here, the sameness of the vector can be determined by comparing the magnitude and direction value of the first vector and the second vector. Alternatively, the sameness of the vector can be determined by comparing only the direction value of the first vector and the second vector.

If user cancels the touch input in the third coordinate, the controller can sense the coordinate (hereinafter, a fourth coordinate) of a spot (a number seven area) touched by the left hand like a fifth exemplary diagram (e). At this time, if user inputs a touch to another area before the touch input of the seventh area is cancelled, the controller can repeat the above described process of storing the moved coordinate and comparing the vector value among the coordinates. On the other hand, if user does not touch another area, or if a touch input cancel signal of the number 7 area is generated before touching, the controller determines the touch of the fourth coordinate as being effective like a sixth exemplary diagram (f), and can control to display the allocated number 7 to the input window 10. Thereafter, the controller can initialize the first buffer and the second buffer.

As described in the above examples, the present invention can solve a conventional error that a character corresponding to an intermediate point is sensed to display, or no character is displayed if a multi-touch is generated. Thus, the claimed invention increases user-convenience and reduces the erroneous display caused from misinterpreting the contact on the touch screen.

FIG. 3 is a flowchart illustrating a multi-touch input process of a piezoelectric type touch screen according to an exemplary embodiment of the present invention.

Referring now to FIGS. 2 to 3, the controller can execute a character input function (301) in character input mode. At this time, as shown in FIG. 2, the controller can display the virtual keypad and the input window to the touch screen.

When the user touches the virtual keypad so as to input a character, the controller receives the coordinate of the touched spot from the touch screen (303). At this time, the controller can set up “N” which indicates the number of the coordinate stored in the first buffer as 1, and can set up “M” which indicates the number of the vector stored in the second buffer as 0 (305). Here, N and M are natural numbers.

The controller can store the coordinate of a spot in which a touch is sensed as a N-th coordinate (307). Here, the first buffer comprises a buffer which successively stores the coordinates which moves without the cancel of a touch input. The first buffer can be initialized in the input of a touch input cancel signal.

The controller can also check whether the touch input cancel signal is generated (308). If the touch input cancel signal is generated at step 308, the controller can direct the display to show a character allocated to the area which includes a N-th coordinate to the input window (331). The controller can check whether an end signal is inputted (333). If the end signal is inputted, the process of the invention can be terminated. On the other hand, if the end signal is not inputted, the controller can return to step 303. The end signal can be a text message writing completion signal.

In the meantime, if the touch input cancel signal is not generated at step 308, the controller can check whether the movement of the coordinate occurs (309). If the movement of the coordinate does not occur, the controller can return to step 308. On the other hand, if the movement of the coordinate occurs at step 309, the controller can check whether the value of N is 1 (311).

With continued reference to FIG. 3, if the value of N is 1 at step 311, the controller can display a character allocated to the N-th coordinate to the input window (312). Then, the controller can proceed to a next step 313. On the other hand, if the value of N is not 1 at step 311, the controller can increase the value of N with 1 (313).

The controller stores the N-th coordinate (315) and can proceed to a next step 317. The controller checks whether the value of N is 2 (317). If the value of N is 2, the controller proceeds to step 308 and can repeat the above described process. On the other hand, in case the value of N is not 2, the controller can calculate a vector value between the (N−1)th coordinate and the N-th coordinate (319). For example, a vector value between the second coordinate and the third coordinate can be calculated. Then, the controller can increase the M value with 1 (321). At this time, since the initial value is 0, the M can be 1. The controller can store the vector value calculated at step 319 into the second buffer as an M vector (323). That is, the controller can store the vector value between the second coordinate and the third coordinate into the second buffer as a first vector.

The controller can check whether the value of M is 1 or less (325). At this time, if the value of M is 1 or less, the controller proceeds to step 308 and can repeat the above described process. On the other hand, if the value of M exceeds 1, the controller can check whether the M−1 vector which is previously stored is identical with the M vector (327). The sameness of the vector can be determined by comparing the magnitude and direction of respective vectors, or can be determined by comparing only the direction.

As a result of the determination of the sameness, in case the M−1 vector and the M vector are identical at step 327, the controller proceeds to step 308 and can repeat the above described process. On the other hand, in case the M—1 vector and the M vector are not identical as a result of the determination, the controller can control the display to show the character allocated to the area which includes the N−1 coordinate to the input window (329). Then, the controller proceeds to step 308 and can repeat the above-described process.

In the meantime, in the above, it was illustrated that the controller checks the sameness of the M—1 vector and the M vector and senses the touch of the N−1 coordinate. However, the present invention is not limited to this function. For example, the present invention can determine that the touch of the N−1 coordinate is effective when an angle formed by the M—1 vector and the M vector is a standard value (e.g. 5 degrees) or more.

The overall configuration of the present invention was illustrated in the above. In summary, according to the present invention, a first coordinate set by a multi-touch, which is a second touch input, is stored in a state where a first touch input is maintained, a second coordinate which is sensed when the first touch input is cancelled is stored in a state where the second touch input is maintained, a third coordinate set by a third touch input is stored in a state where the second touch input is maintained, the sameness of a first vector from the first coordinate to the second coordinate and a second vector from the second coordinate to the third coordinate is determined, and in case the first vector and the second vector are not identical, the touch of the second coordinate is determined as being effective. Thereafter, a fourth coordinate which is sensed in the cancel of the second touch input is stored, and the touch of the fourth coordinate is determined as being effective in the cancel of the third touch input.

Moreover, in the above description, it was illustrated that the coordinate moving without the touch cancel is successively stored in the first buffer 121, but the present invention is not limited to this description. That is, the first buffer 121 can store only three coordinates. That is, if a new coordinate is inputted, the oldest coordinate is deleted and rest coordinates are successively moved, so that the new coordinate can be stored as a third coordinate. Accordingly, the second buffer 122 can calculate and store two vector values caused by the change of the coordinate of the first buffer 121.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims. For example, although five degrees is disclosed in the above examples, an artisan should understand and appreciate that such a value is substantially that value, and could be more or less. In addition, other angles could be selected as being within the spirit and scope of the invention.

What is claimed is:

1. A method of processing a touch input of a touch screen, the method comprising:
sensing a first touch input on the touch screen;
storing a first coordinate sensed as a multi-touch input that becomes a second touch input in a state in which the first touch input on the touch screen is maintained;
cancelling the first touch input in a state in which the second touch input is maintained;
storing a second coordinate set in response to a cancelation of the first touch input;
storing a third coordinate set by a third touch input in a state in which the second touch input on the touch screen is maintained; and
checking a sameness of a first vector from the first coordinate to the second coordinate and a second vector from the second coordinate to the third coordinate, and determining a touch of the second coordinate as being effective in case the first vector and the second vector are not identical.

2. The method of claim 1, wherein checking the sameness of a first vector and a second vector comprises at least one of:
comparing a direction value of the first vector and the second vector; and
comparing a direction value and magnitude of the first vector and the second vector.

3. The method of claim 1, wherein checking the sameness of a first vector and a second vector comprises checking whether an angle formed by the first vector and the second vector comprises a predefined standard value or greater.

4. The method of claim 3, wherein the standard value comprises substantially five degrees.

5. The method of claim 1, further comprising:
storing a fourth coordinate set by a cancel of the second touch input; and
determining a touch of the fourth coordinate as being effective in a cancel of the third touch input.

6. The method of claim 1, further comprising:
storing a coordinate which is sensed by the first touch input, and determining the first touch input as being effective in the second touch input.

7. The method of claim 1, further comprising:
storing a coordinate which is sensed by the first touch input, and determining the first touch input as being effective in the cancelation of the first touch input.

8. The method of claim 1, further comprising:
outputting a virtual keypad display to the touch screen; and
outputting to the touch screen a character corresponding to a key allocated to a coordinate which is determined to be effective among coordinates stored due to a touch input through the virtual keypad.

9. An apparatus of processing a touch input of a touch screen, the apparatus comprising:
a touch screen configured for sensing a touch input of user;
a first buffer configured for storing a first coordinate set by a second touch input in a state in which a previously sensed first touch input is maintained on touch screen, to store a second coordinate set by a cancel of the first touch input, and to store a third coordinate set by a third touch input sensed by the touch screen in a state in which the second touch input is maintained;
a vector calculation unit configured for calculating a first vector between the first coordinate and the second coordinate, and for calculating a second vector between the second coordinate and the third coordinate if the third coordinate is inputted to a storage unit;
a second buffer configured for storing the first vector and the second vector calculated by the vector calculation unit; and
a controller configured for checking a sameness of the first vector and the second vector that are stored in the second buffer, and to determine a touch of the second coordinate as being effective in case the first vector and the second vector are not identical.

10. The apparatus of claim 9, wherein the controller compares at least one of a direction value of the first vector and the second vector, or a direction value and magnitude of the first vector and the second vector, so that the controller determines a touch of the second coordinate as being effective in a case of the first vector and the second vector not being identical.

11. The apparatus of claim 9, wherein the controller determines a touch of the second coordinate as being effective in case an angle formed by the first vector and the second vector comprises a predefined standard value or greater.

12. The apparatus of claim 11, wherein the standard value comprises substantially five degrees.

13. The apparatus of claim 9, wherein the first buffer stores a fourth coordinate set by a cancel of the second touch input, and the controller determines a touch of the fourth coordinate as being effective in a cancel of the third touch input.

14. The apparatus of claim 9, wherein the controller stores a coordinate which is sensed by the touch screen in an input of the first touch, and determines an input of the first touch as being effective in the input of the second touch.

15. The apparatus of claim 9, wherein the controller stores a coordinate which is sensed by the touch screen in an input of the first touch, and determines an input of the first touch as being effective in the cancel of the first touch input.

16. The apparatus of claim 9, wherein the touch screen displays a character corresponding to a key allocated to a coordinate that is determined to be effective among coordinates stored due to the touch input.

17. The apparatus of claim 9, wherein the touch screen comprises a piezoelectric type touch screen.

18. The apparatus of claim 9, wherein a canceled input comprises sensing a release of touch against the touch screen.
